(19) United States
(12) Patent Application Publication
(10) Pub. No.: US 2009/0236863 A1
(43) Pub. Date: Sep. 24, 2009

(54) ELECTRIC DOOR LATCH APPARATUS

(75) Inventors: Ryujiro AKIZUKI, Kariya-shi (JP); Takeshi TADA, Okazaki-shi (JP); Yoshinobu OGURA, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/408,288

(22) Filed: Mar. 20, 2009

(30) Foreign Application Priority Data
Mar. 24, 2008 (JP) 2008-074990

(51) Int. Cl. E05C 3/06

(52) U.S. Cl. 292/201

(57) ABSTRACT

An electric door latch apparatus includes a manual operation portion adapted to be mounted on a vehicle door and configured to be switched between a closed door retaining state in which the vehicle door is retained at a closed position and a door openable state in which the vehicle door is openable by an electric actuation, the manual operation portion being switched from the closed door retaining state to the door openable state by a manual operation in an electrically inoperable condition, and the manual operation portion positioned within the vehicle door and including a tool fitting hole on a surface thereof facing a vehicle compartment side wall portion of the vehicle door. The manual operation portion is configured to be rotated by fitting a predetermined tool into the tool fitting hole via an operation hole formed penetrating through the vehicle compartment side wall portion of the vehicle door.

### CROSS REFERENCE TO RELATED APPLICATIONS

This application is based on and claims priority under 35 U.S.C. §119 to Japanese Patent Application 2008-074990, filed on Mar. 24, 2008, the entire contents of which is incorporated herein by reference.

### FIELD OF THE INVENTION

The present invention relates to an electric door latch apparatus.

### BACKGROUND

According to a known electric door latch apparatus, for example, disclosed in JP2001-311337A, an operational knob for operating a manual operation portion is exposed on a vehicle interior wall surface (door trim) of a door (See paragraph [0026], FIGS. 1-2). With the construction of the known electric door latch apparatus disclosed in JP2001-311337A) because the operational knob is provided at a position to which a passenger's hand can relatively readily reach and the operational knob is always in an operable state, a state is unintentionally switched to a door openable state by an inappropriate operation of the operational knob, for example, by a child's mischief even in a normally operated state in which the state can be switched by an electric activation. In order to countermeasure the forgoing problem, according to a known electric door latch apparatus disclosed in JP2006-45893A (see paragraph [0023], FIG. 1), an operational lever connected to a manual operation portion is arranged under a seat, and further, the operational lever is covered by a cover member when a seat is not occupied.

Notwithstanding the construction of the known electric door latch apparatus disclosed in JP2006-45893A, because the operational lever is exposed to the vehicle compartment under the seat when the seat is occupied, inappropriate operations of the operational lever can still not be prevented securely. On the contrary, in a case where the operational lever actually needs to be operated because the electric door latch apparatus becomes electrically inoperable, an operator has to look under the seat or has to grope for the operational lever under the seat. Thus, the construction of the known electric door latch apparatus disclosed in JP2006-45893A is inferior to the known electric door latch apparatus disclosed in JP2001-311337A in terms of a level of visibility.

A need thus exists for an electric door latch apparatus which is not susceptible to the drawback mentioned above.

### SUMMARY OF THE INVENTION

In light of the foregoing, the present invention provides an electric door latch apparatus, which includes a manual operation portion adapted to be mounted on a vehicle door and configured to be switched between a closed door retaining state in which the vehicle door is retained at a closed position and a door openable state in which the vehicle door is openable by an electric actuation, the manual operation portion being switched from the closed door retaining state to the door openable state by a manual operation in an electrically inoperable condition, and the manual operation portion positioned within the vehicle door and including a tool fitting hole on a surface thereof facing a vehicle compartment side wall portion of the vehicle door. The manual operation portion is configured to be rotated by fitting a predetermined tool into the tool fitting hole via an operation hole formed penetrating through the vehicle compartment side wall portion of the vehicle door.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a plane view of an electric door latch apparatus according to a first embodiment of the present invention;

FIG. 2 is a perspective view of the electric door latch apparatus according to the first embodiment of the present invention;

FIG. 3 is a side view of the electric door latch apparatus according to the first embodiment of the present invention;

FIG. 4 is a front view of a striker engagement mechanism portion in a closed door retaining state;

FIG. 5 is a front view of the striker engagement mechanism portion in a door openable state;

FIG. 6 is a cross-sectional view taken on line VI-VI in FIG. 4;

FIG. 7 is a front view of an actuating mechanism portion in the closed door retaining state;

FIG. 8 is a front view of the actuating mechanism portion in a process of switching between the closed door retaining state and the door openable state;

FIG. 9 is a front view of the actuating mechanism portion in the door openable state;

FIG. 10 is a cross-sectional view taken on line X-X in FIG. 3;

FIG. 11 is a plane view of a manual operation member and a ratchet driving plate;

FIG. 12 is a lateral cross-sectional view of the manual operation member and an operational hole attachment;

FIG. 13 is an exploded perspective view of the operational hole attachment viewed from its backside;

FIG. 14 is a plane view of a manual operation member and a ratchet driving plate according to a modified example of the first embodiment of the present invention;

FIG. 15 is a plane view of a manual gear member and a ratchet driving plate according to a second embodiment of the present invention; and

FIG. 16 is an exploded perspective view of an operational hole attachment according to a modified example of the embodiment.

### DETAILED DESCRIPTION

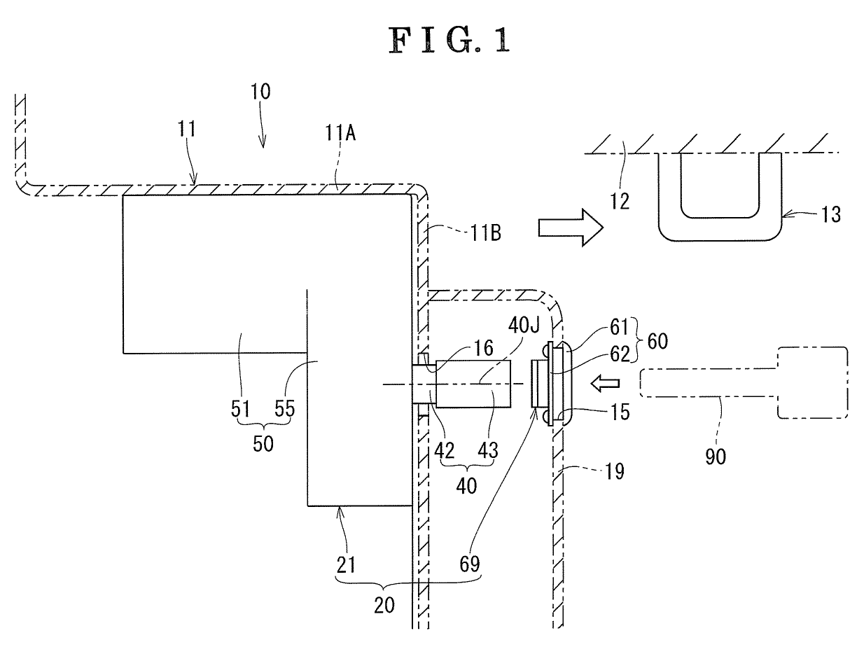

Embodiments of the present invention will be explained with reference to illustrations of drawing figures as follows. A first embodiment of the present invention will be explained referring to FIGS. 1-14. As shown in FIG. 1, a vehicle door 10 includes an outer panel 11 made from a pressed metal sheet. A door trim (lining) 19 is attached on an outer panel side portion wall 11B serving as an interior surface of the outer panel 11. An electric door latch apparatus 20 is mounted on the vehicle door 10 at an opposite side from a rotational center of the vehicle door 10. The electric door latch apparatus 20 includes a main body unit 21 housed within the vehicle door 10 and an operational hole attachment 69 provided at the door trim (i.e., serving as the vehicle compartment side wall portion) 19. The main body unit 21 has a cross section formed approximately in an L-shape when viewed from upward, and is fixed to the vehicle door 10 in a state where a corner portion of the main body unit 21 is fitted to a corner portion of the vehicle door 10 at an end of vehicle's interior side.

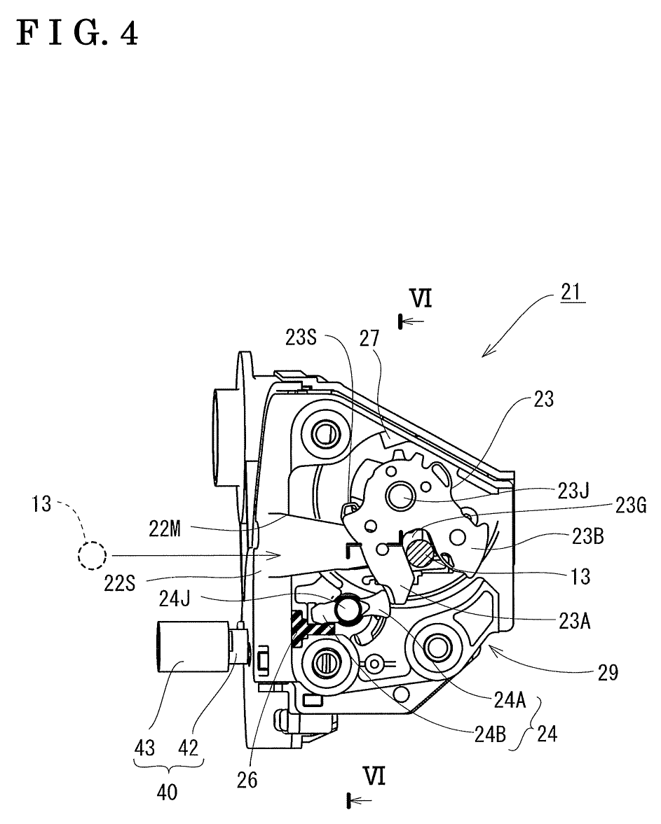

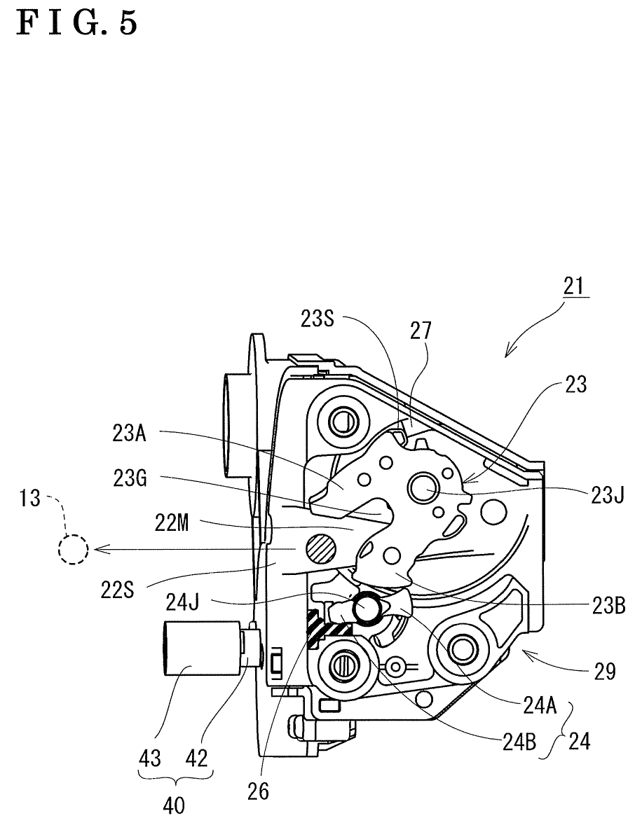

A striker 13 is provided on an inner surface of a doorframe 12 of the vehicle. The striker 13 is, for example, formed by bending a wire rod having a circular cross section into an approximately I-shape, and is arranged to project in an approximately horizontal direction. Further, the striker 13 is arranged so that leg portions thereof are positioned in parallel to each other in an open-close direction of the vehicle door 10 (i.e., right-left direction in FIG. 1). One of the leg portions is engaged with the main body unit 21 of the electric door latch apparatus 20. A cross-sectional view of a portion of the striker 13, which is engaged with the main body unit 21, is shown in FIGS. 4-5. A striker receiving portion which is configured to receive the striker 13 is formed as a cutout at a corner portion where a outer panel end portion wall 11A serving as an end surface of the outer panel 11 of the vehicle door 10 and the outer panel side portion wall 11B are positioned perpendicular to each other.

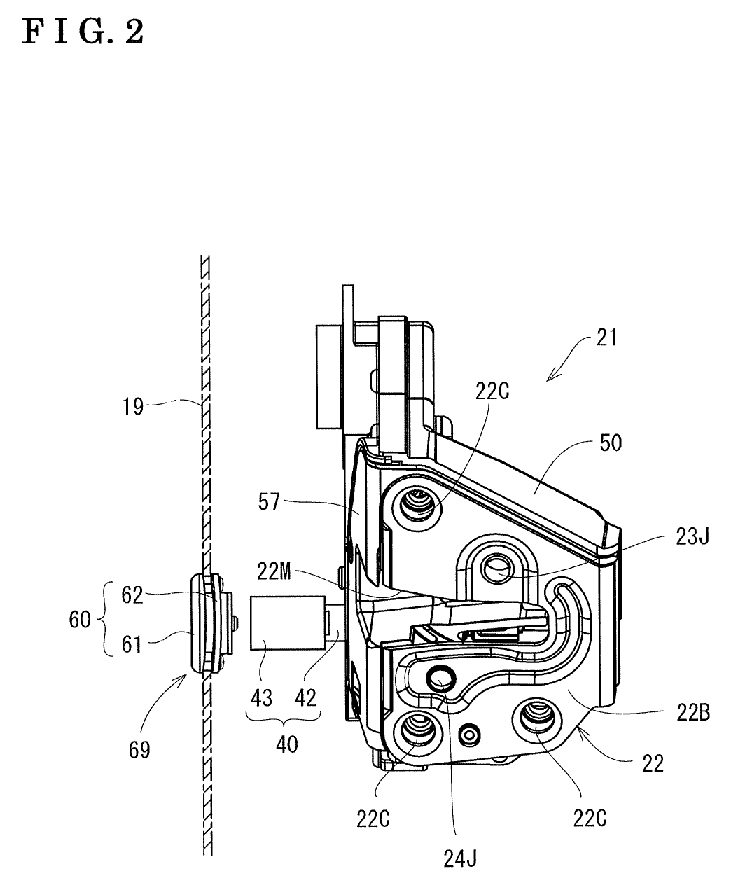

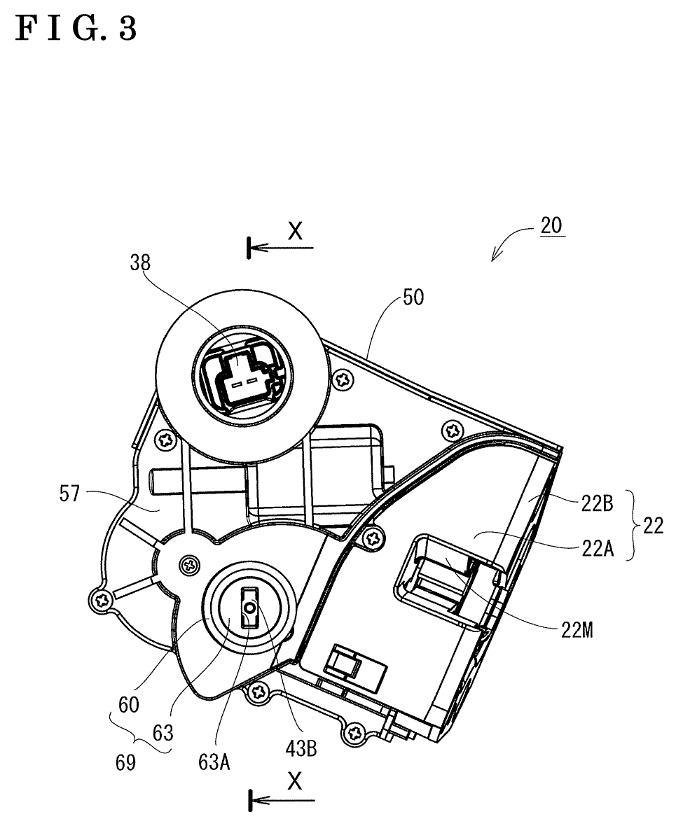

The main body unit 21 includes a striker engagement mechanism portion 29 provided at a portion facing the outer panel end portion wall 11A of the vehicle door 10 and configured to engage with the striker 13. The main body unit 21 further includes an actuating mechanism portion 39 provided at a portion facing the outer panel side portion wall 11B of the vehicle door 10 and is configured to electrically actuate the striker engagement mechanism portion 29. A housing 50 made of resin covers an approximately entire portion of the main body unit 21. The resin-made housing 50, as shown in FIG. 1, includes a mechanism cover portion 51 facing the outer panel end portion wall 11A and a case main body portion 55 facing the outer panel side portion wall 11B. A mechanism case 22 is fitted to the mechanism cover portion 51 and a side portion opening of the case main body portion 55 is covered by a cover body 57 (see FIGS. 2-3).

The striker engagement mechanism portion 29 includes a latch 23 and a ratchet 24 (see FIG. 4) housed in the mechanism case 22. The mechanism case 22 is formed by assembling an approximately flat container shaped member 22A made of resin to a metal sheet member 22B. The metal sheet member 22B is applied to the outer panel end portion wall 11A of the vehicle door 10. A rear portion, an upper portion, and a side portion of the mechanism case 22 are covered by the cover portion 51 (FIG. 1) of the resin-made housing 50.

As shown in FIG. 2, the mechanism case 22 includes bolt fixing portions 22C (e.g., three portions in FIG. 2). The main body unit 21 is fixed to the vehicle door 10 by applying the mechanism case 22 to an inner surface of the outer panel end portion wall 11A and by screwing a bolt, which penetrates the outer panel end portion wall 11A from outside, to the bolt fixing portion 22C. Further, a striker groove 22M is formed on the mechanism case 22 in accordance with the striker receiving portion formed on the outer panel 11 (see FIGS. 2-3). In response to an opening or closing operation of the vehicle door 10, the striker 13 ingresses to or egresses from the striker groove 22M (see FIGS. 4-5).

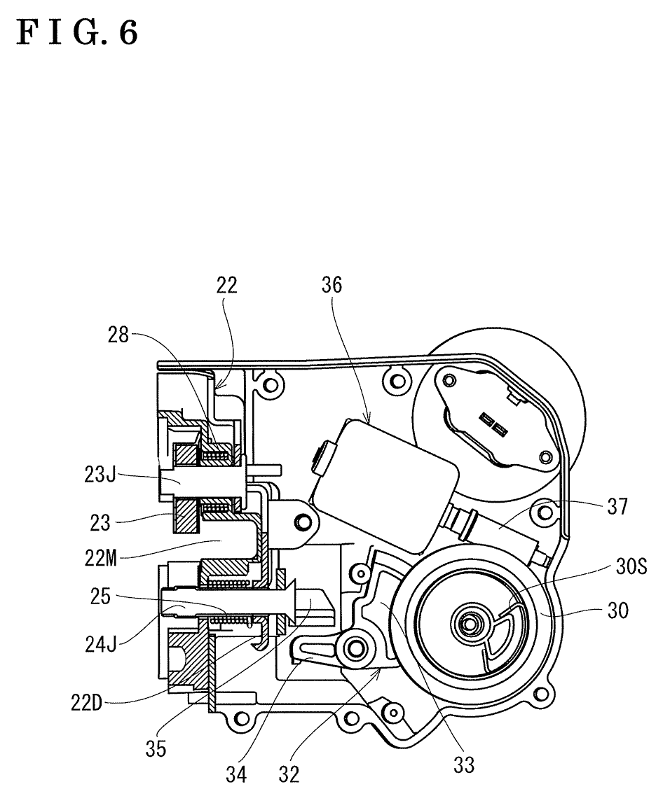

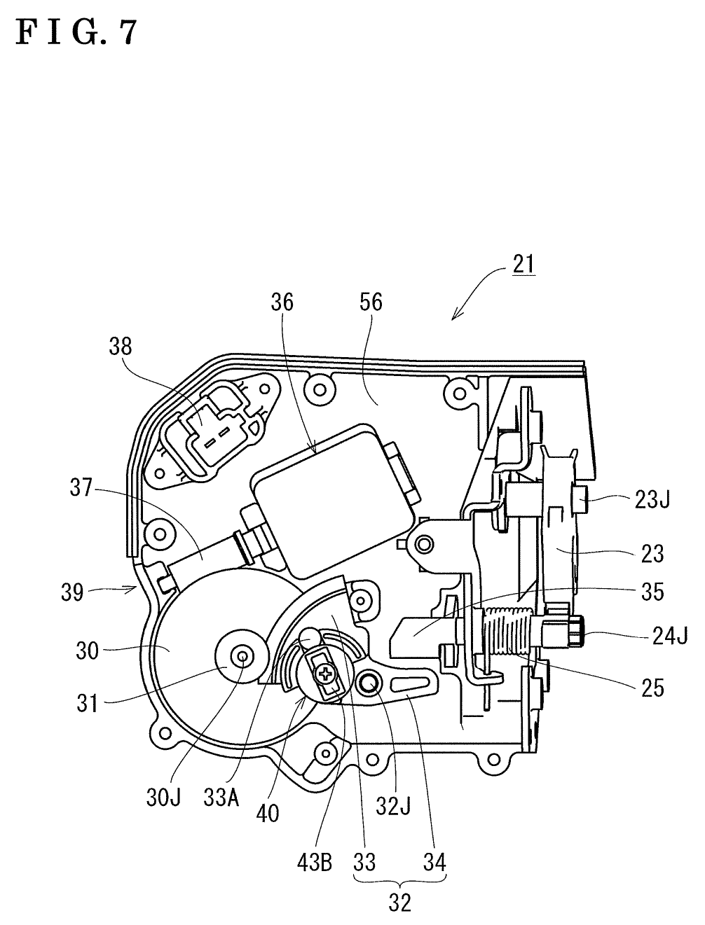

As shown in FIG. 4, the ratchet 24 of the striker engagement mechanism portion 29 is rotatably positioned at a lower level than the striker groove 22M. The ratchet 24 integrally includes a ratchet support shaft 24J and is rotatably supported relative to the metal sheet member 22B and a sub-base 22D of the mechanism case 22 by means of the ratchet support shaft 24J. The ratchet 24 further includes a latch contact piece 24A and a stopper contact piece 24B which are arranged extending in directions being away from the ratchet support shaft 24J. A torsion spring 25 (see FIGS. 6-7) is provided between the ratchet 24 and the mechanism case 22. The ratchet 24 is biased in a counterclockwise direction in FIG. 4 by means of the torsion spring 25. A positioning of the ratchet 24 is defined by the stopper contact piece 24B contacting a ratchet stopper 26 which is made of rubber and provided at the mechanism case 22. The position of the ratchet 24 in this state serves as a latch engagement position according to the embodiment of the present invention.

A latch support shaft 23J of the striker engagement mechanism portion 29 is positioned at a higher level than the striker groove 22M and the latch 23 is rotatably supported by means of the latch support shaft 23J. The latch 23 is configured to soundproof by covering a metal plate with resin. The latch 23 includes a pair of engagement pawls 23A, 23B which are arranged approximately in parallel to each other. The void between the engagement pawls 23A, 23B serves as a striker receiving portion 23G. A stopper contact portion 23S is formed on the latch 23 to project therefrom at a portion opposite from an extending direction of the engagement pawl 23A. In the event that the latch 23 rotates in a clockwise direction from a latched position shown in FIG. 4, the stopper contact portion 23S comes in contact with a latch stopper 27 formed on the mechanism case 22 to position the latch 23 in an unlatched position shown in FIG. 5.

The latch 23 is biased towards an unlatched position side by means of a torsion spring 28 (see FIG. 6) provided between the mechanism case 22 and the latch 23. In a state where the vehicle door 10 is open, the latch 23 is positioned at the unlatched position shown in FIG. 5. In the unlatched position, one of the engagement pawls 23A (hereinafter referred to as a front side engagement pawl 23A) is retracted to the position higher than the striker groove 22M and the other engagement pawl 23B (hereinafter referred to as a rear side engagement pawl 23B) is positioned on the striker groove 22M, and an opening end of the striker receiving portion 23G faces a striker entrance 22S of the striker groove 22M.

When closing the vehicle door 10 in the foregoing state, the striker 13 which enters, or ingresses the striker groove 22M is received within the striker receiving portion 23G, and the striker 13 pushes the rear side engagement pawl 23B to rotate the latch 23 in the counterclockwise direction in FIG. 5. In those circumstances, the latch contact piece 24A of the ratchet 24 is pushed by the front side engagement pawl 23A and the rear side engagement pawl 23B so that the ratchet 24 rotates against a biasing force of the torsion spring 25. When closing the vehicle door 10, as shown in FIG. 4, a portion of the striker groove 22M closer to the striker entrance 22S relative to the striker 13 is blocked by the front side engagement pawl 23A so that the latch 23 and the striker 13 are engaged with each other. In the meantime, the latch contact piece 24A of the ratchet 24 comes to engage a front side of the front side engagement pawl 23A to restrict the rotation of the latch 23 towards the unlatched side (in the clockwise direction in FIG. 4). Thus, the vehicle door 10 is retained at the closed state. This state is defined as a closed door retaining state.

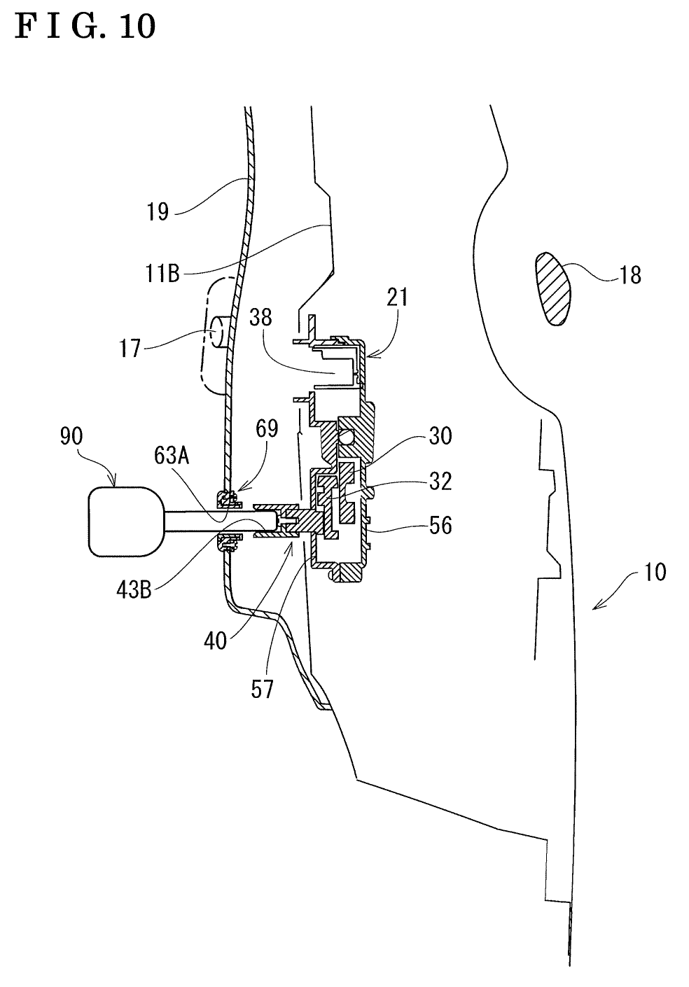

In case of opening the vehicle door 10 in the foregoing state, the ratchet 24 is rotated to retract the latch contact piece 24A from a contacting position with the front side engagement pawl 23A. In order to rotate the ratchet 24, an inside door lever 17 is provided at an interior side of the vehicle door 10 and an outside door lever 18 is provided at an outside of the vehicle door 10 as shown in FIG. 10. The door levers 17, 18 are connected to switches which are configured to turn on and off in response to the operation of the door levers 17, 18, respectively. The switches and a motor 36 provided at the actuating mechanism portion 39 are electrically connected.

As shown in FIG. 7, the actuating mechanism portion 39 includes plural members including the motor 36 and is housed within the case main body portion 55 of the resin-made housing 50. A connector portion 38 is provided on the case main body portion 55 at a top corner portion of an attachment wall 56 which faces the cover body 57. The motor 36 is assembled within the case main body portion 55 at a lower level relative to the connector portion 38. The connector portion 38 and the motor 36 are connected by a wire.

A worm wheel rotational shaft 30J is provided on the attachment wall 56 to project towards the cover body 57 at a lower level relative to the motor 36. A worm wheel 30 is rotatably supported on the worm wheel rotational shaft 30J. The worm wheel 30 is geared with a worm gear 37 provided at an output rotation portion of the motor 36.

A spur gear 31 is pivotally supported in a state being overlapped on the worm wheel 30 in a thickness direction. The spur gear 31 has a smaller diameter than that of the worm wheel 30 and is configured to always integrally rotate with the worm wheel 30.

A driving plate rotational shaft (i.e., serving as a rotational shaft of the sector gear) 32J is provided on the attachment wall 56 at a position between the worm wheel 30 and the mechanism case 22 in a manner projecting to be in parallel to the worm wheel rotational shaft 30J. A ratchet driving plate 32 is rotatably supported on the driving plate rotational shaft 32J.

The ratchet driving plate 32 includes a sector gear plate (i.e., serving as a the sector gear) 33 and a release lever 34. The sector gear plate 33 and the release lever 34 are arranged to extend in opposite directions relative to the driving plate rotational shaft 32J. The sector gear plate 33 includes a sector configuration having a rotation center of the ratchet driving plate 32 as a center. Further, the sector gear plate 33 is arranged to overlap a portion of the worm wheel 30 and a peripheral portion of the sector gear plate 33 is geared with the spur gear 31. On the other hand, the release lever 34 is positioned at a lower level relative to a lift lever (i.e., serving as a rotational projection portion) 35 which is provided on a rear side of the mechanism case 22 and always integrally rotates with the ratchet 24.

In the event that either the inside door lever 17 or the outside door lever 18 are operated in order to open the vehicle door 10, the worm wheel 30 is rotated by an actuation of the motor 36 in the clockwise direction in FIG. 7, the ratchet driving plate 32 is rotated in the counterclockwise direction in FIG. 7 in response to the clockwise rotation of the worm wheel 30, and the release lever 34 lifts a lift lever (i.e., serving as a rotational projection portion) 35 from the bottom in an upward direction. In consequence, the ratchet 24 rotates in the clockwise direction in FIG. 4 while slidably contacting the front side engagement pawl 23A of the latch 23 so as to be retracted from a moving region of the latch 23 as shown in FIG. 5. That is, the ratchet 24 in this state serves as a latch engagement release position where the latch 23 is rotatable towards the unlatched position. Accordingly, a door openable state in which the vehicle door 10 is allowed to open is established. In the event that an opening operation for the vehicle door 10 is preformed (either pushing a door from a vehicle compartment side or pulling a door from the outside of the vehicle), the striker 13 moves towards the striker entrance 22S of the striker groove 22M and the latch 23 rotates towards the unlatched position (i.e., in the clockwise direction in FIG. 4) by means of a biasing force of the torsion spring 28.

A return spring 30S (see FIG. 6) biasing the worm wheel 30 in the counterclockwise direction in FIG. 7 is provided between the worm wheel 30 and the attachment wall 56. In a case where the motor 36 is not energized, the ratchet driving plate 32 is configured to return to an initial position shown in FIG. 7 by means of the return spring 30S.

More particularly, when the inside door lever 17 or the outside door lever 18 is in operation, the motor 36 is actuated to rotate the ratchet 24 towards the unlatched position, or latch disengagement position by the ratchet driving plate 32. However, in those circumstances, in a case where the operation of the inside door lever 17 or the outside door lever 18 is stopped or in a case where a predetermined time elapses after a start of the operation of the inside door lever 17 or the outside door lever 18, the motor 36 is de-energized so that the ratchet driving plate 32 returns to the initial position by the biasing force of the return spring 30S.

The electric door latch apparatus 20 of the embodiment includes a manual rotation member (i.e., serving as a manual operation portion) 40 which allows to switch from the closed door retaining state to the door openable state by a manual operation at the inside of the vehicle compartment. The manual rotation member (i.e., serving as the manual operation portion) 40 is provided as a countermeasure for a case where the electric actuation is inoperable because of a trouble caused by/of the motor 36 or other electric systems in the closed door retaining state shown in FIG. 4.

According to this embodiment, the manual rotation member 40 is connected to the ratchet driving plate 32 among plural motor torque transmitting members (e.g., the worm wheel 30, the spur gear 31, the ratchet driving plate 32) for transmitting a torque of the motor 36 to the ratchet 24.

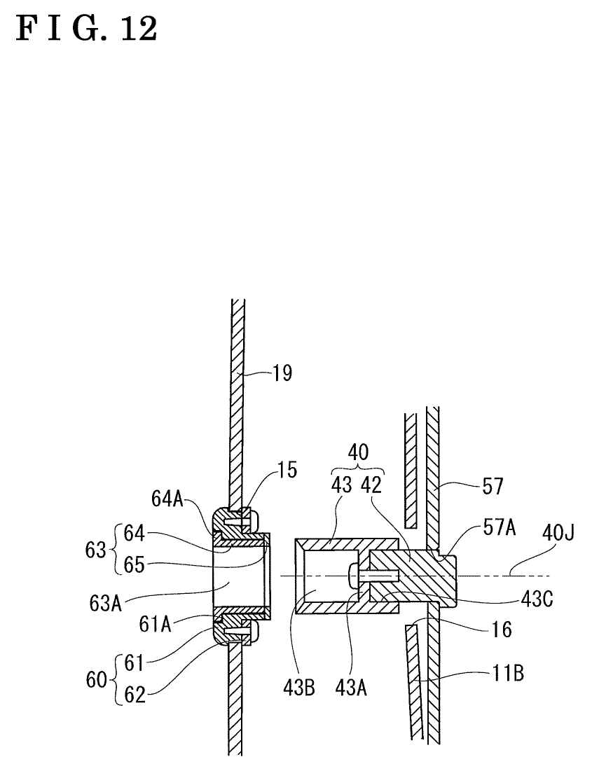

As shown in FIG. 7, the manual rotation member 40 is positioned overlapping the sector gear plate 33 of the ratchet driving plate 32 in the plate thickness direction. The manual rotation member 40 is formed in a column configuration which is arranged in parallel to the worm wheel rotational shaft 30J and the driving plate rotational shaft 32J. As shown in FIG. 12, the manual rotation member 40 is positioned penetrating through a penetration hole 57A formed on the cover body 57. A base end portion of the manual rotation member 40 is rotatably fitted into the penetration hole 57A.

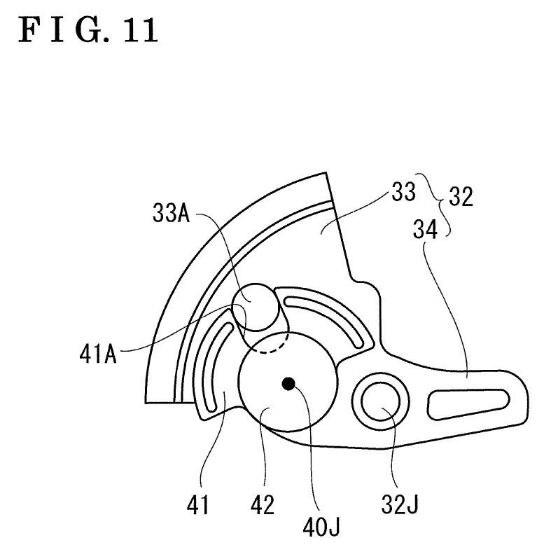

A connection plate 41 is provided at a portion of the base end portion of the manual rotation member 40. As shown in FIG. 11, the connection plate 41 extends in a radially outward direction of the manual rotation member 40 and has a half-circle like configuration. The connection plate 41 retains the manual rotation member 40 to the penetration hole 57A.

A connection mechanism including a projection portion 33A and a guide slot 41A which engage with each other via a projection and a recess is formed on opposing surfaces of the manual rotation member 40 and the sector gear plate 33. That is, the projection portion 33A is formed on a surface of the sector gear plate 33 which faces the manual rotation member 40 and the guide slot 41A is formed on a surface of the manual rotation member 40 facing the sector gear plate 33. The projection portion 33A and the guide slot 41A are engaged with each other via the projection and the recess, thus forming a connection mechanism More particularly, the projection portion 33A having a column shape projecting towards the manual rotation member 40 is provided on the sector gear plate 33 at a middle position thereof in a circumferential direction. The guide slot 41A which extends in a radial direction and opens outward in the radial direction is formed on the connection plate 41 of the manual rotation member 40.

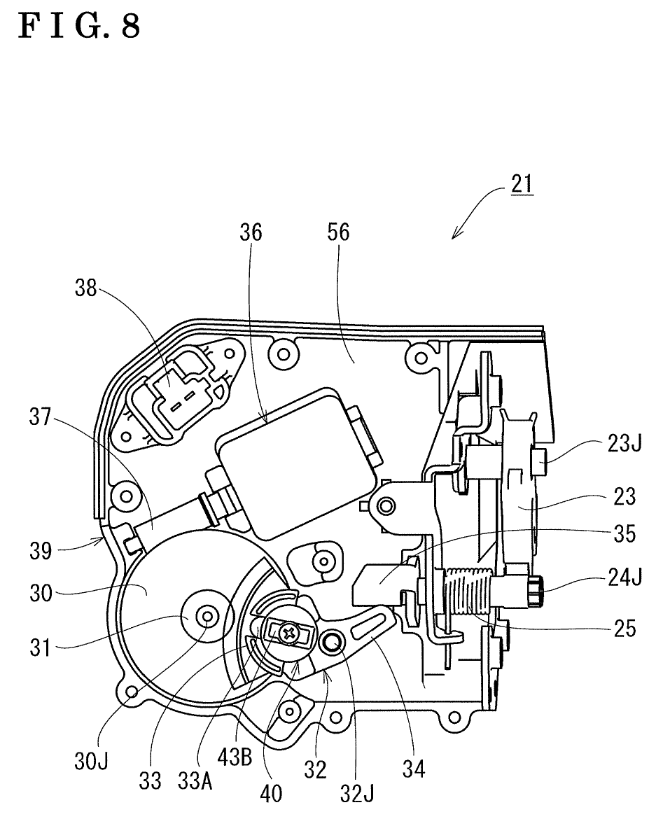

As shown in FIG. 11, a rotational axis 40J of the manual rotation member 40 is arranged to be in parallel to and to be offset from the driving plate rotational shaft 32J. Further, as shown in FIG. 8, the rotational axis 40J of the manual rotation member 40 is arranged to be positioned at a middle position on a line connecting the driving plate rotational shaft 32J and the projection portion 33A when the worm wheel rotational shaft 30J, the driving plate rotational shaft 32J and the projection portion 33A are arranged in a straight line.

As shown in FIG. 12, the manual rotation member 40 includes a base end piece 42 which integrally includes the connection plate 41 and a top end piece 43 having a cylindrical structure. The base end piece 42 and the top end piece 43 are fixedly connected each other. An inner wall 43A is provided at an axially middle portion of the top end piece 43. A connection hole 43C to which a top end portion of the base end piece 42 is fitted is formed at a portion of the manual rotation member 40 closer to the base end side relative to the inner wall 43A. A tool fitting hole 43B having a non-circular cross section is formed at a portion of the manual rotation member 40 closer to a top end side relative to the inner wall 43A. As shown in FIG. 7, the tool fitting hole 43B is configured to have, for example, a rectangular cross section to which a key plate (i.e., serving as a predetermined tool) 90 for starting a vehicle engine can be fitted. Edge portions of an opening rim of the tool fitting hole 43B (i.e., edge portions formed by an inner surface of the tool fitting hole 43B and a top end surface of the top end piece 43) are chamfered to have a tapered configuration. The top end piece 43 and the base end piece 42 are connected by means of a screw which penetrates the inner wall 43A from the tool fitting hole 43B side of the top end piece 43. The manual rotation member 40 is formed accordingly. By structuring the connection hole 43C of the top end piece 43 and the top end portion of the base end piece 42 to have the non-circular cross section, a relative rotation between the top end piece and the base end piece 42 can be securely restricted.

As shown in FIG. 12, a first operation hole (i.e., serving as an operation hole) 15 and a second operation hole 16 are formed penetrating through the door trim 19 and the outer panel side portion wall 11B which form a side surface of an interior of the vehicle door 10, respectively. The first operation hole 15 and the second operation hole 16 are formed at portions of the door trim 19 and the outer panel side portion wall 11B facing the manual rotation member 40 (i.e., on an extension line of the rotational axis 40J of the manual rotation member 40). The manual rotation member 40 penetrating through the cover body 57 and projecting from the resin-made housing 50 penetrates the second operation hole 16 which is formed on the outer panel side portion wall 11B. A top end portion of the manual rotation member 40 is positioned in the void of the vehicle door 10 formed between the outer panel side portion wall 11B and the door trim 19. Namely, the top end portion of the manual rotation member 40 does not project from the door trim 19 and is positioned inside of the first operation hole 15 facing the first operation hole 15.

The operational hole attachment 69 which serves as a portion of the electric door latch apparatus 20 is mounted on the first operation hole 15 formed on the door trim 19. The operational hole attachment 69 includes a secure ring 60 which is fixed to a rim portion of the first operation hole 15 and a movable plate 63 rotatably assembled within the secure ring 60.

The secure ring 60 includes a substantially cylindrical shape having an axial dimension smaller relative to a diameter. A top end portion of a ring main body 61 of the secure ring 60, which is configured to be inserted into the first operation hole 15 has a flange configuration. Thus, the top end portion of the ring main body 61 is configured to be engaged with an opening rim of the first operation hole 15 facing the vehicle interior. The ring main body 61 includes a cylindrical inner surface and an engagement stepped portion 61A at which an inner diameter is expanded stepwise is formed at an opening rim of the top end portion. The secure ring 60 is fixed by sandwiching the door trim 19 (circumferential rim portion of the first operation hole 15) between the secure ring 60 and a retaining ring 62 which is retained to the ring main body 16 by means of screws from a backside of the door trim 19 in a plate thickness direction in a state where the ring main body 61 is inserted in the first operation hole 15. The first operation hole 15 and a portion fitting into the first operation hole 15 of the ring main body 61 is configured to have a non-circular cross section so that the secure ring 60 does not rotate relative to the first operation hole 15.

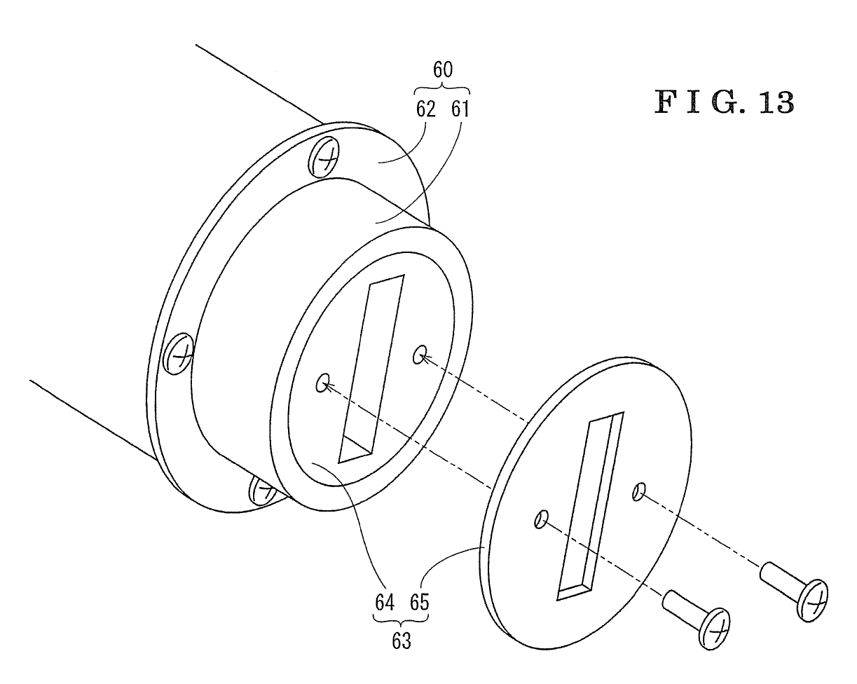

The movable plate 63 is formed in a column shape having an axial dimension smaller relative to a diameter. A flange 64A of the movable plate 63 is integrally formed on a top end portion of a plate main body 64 which is fitted into the secure ring 60. The flange 64A is engaged with the engagement stepped portion 61A of the secure ring 60. Further, as shown in FIG. 13, a flange plate 65 is secured to a base end portion of the plate main body 64 by means of screws so that the movable plate 63 is retained to the secure ring 60. The movable plate 63 is retained to the secure ring 60 by the flange 64A of the plate main body 64 and the flange plate 65.

A key insertion hole 63A is formed penetrating through the movable plate 63. The key insertion hole 63A penetrates through the movable plate 63 (plate main body 64 and the flange plate 65) in an axial direction and includes a rectangular cross section to which the key plate 90 for starting the vehicle engine can be inserted. The configuration of the key insertion hole 63A and cross-sectional configuration of the tool fitting hole 43B formed on the manual rotation member 40 is approximately the same. The key insertion hole 63A and the tool fitting hole 43B coincide with each other in an aligning direction of the movable plate 63 and the manual rotation member 40 as shown in FIG. 3. The electric door latch apparatus 20 is structured accordingly.

Next, an operation for switching door states from the closed door retaining state to the door openable state by manually operating the manual rotation member 40 in the event that the electric door latch apparatus 20 becomes electrically inoperable in the closed door retaining state (i.e., shown in FIG. 4) will be explained hereinafter.

In order to rotate the manual rotation member 40, first, the key plate 90 is inserted into the first operation hole 15 of the door trim 19 and is fitted to the tool fitting hole 43B of the manual rotation member 40 provided at the inner side of the door trim 19 (shown in FIG. 10). When rotating the key plate 90 in the counterclockwise direction viewed from the vehicle interior side in the state where the key plate 90 is fitted to the tool fitting hole 43B shown in FIG. 10, the manual rotation member 40 rotates in the same direction to the rotating direction of the key plate 90, and the ratchet driving plate 32 connected to the manual rotation member by means of the connection mechanism (projection portion 33A and the guide slot 41A) rotates in the counterclockwise direction in FIG. 7. Accordingly, the release lever 34 of the ratchet driving plate 32 comes in contact with a bottom surface of the lift lever 35 to lift the lift lever 35 in the upward direction.

In response to the movement of the lift lever 35 in the upward direction, the ratchet 24 rotates integrally with the lift lever 35 in the clockwise direction in FIG. 4 while slidably contacting the front side engagement pawl 23A of the latch 23 to be retracted from the moving range of the latch 23. Accordingly, the latch 23 becomes rotatable to the unlatched position side and the door state is switched to the door openable state. In the door openable state, the vehicle door 10 can be opened if the vehicle door 10 is pushed from the vehicle compartment side. That is, even when the electric door latch apparatus 20 becomes electrically inoperable in the closed door retaining state, the door state is manually switched to the door openable state, and thus, occupants are able to egress from the vehicle.

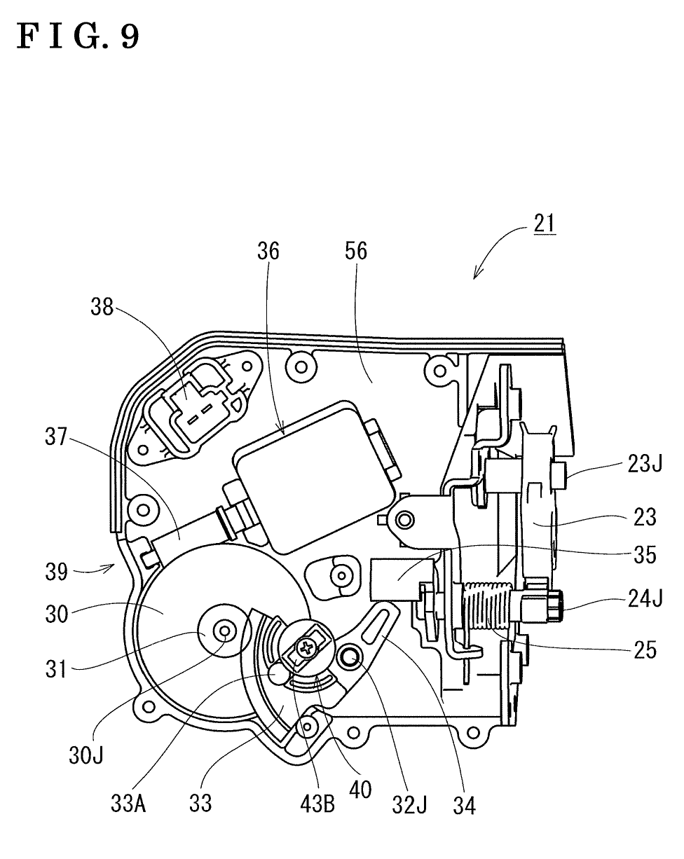

In the event that the rotation of the motor 36 deteriorates in the door openable state of the electric door latch apparatus 20 (shown in FIG. 9) or that the return spring does not work, the door state may not be switched to the closed door retaining state. Because of this drawback, even if the vehicle is operable, it cannot be actually operated. With the construction of the electric door latch apparatus 20 according to the embodiment, because the manual rotation member 40 is connected to one of the plural motor torque transmitting members for transmitting the torque of the motor 36 to the ratchet 24, that is, the ratchet driving plate 32, in the event that the electric door latch apparatus 20 becomes electrically inoperable in the door openable state, for example, shown in FIG. 9, the door state can be manually switched to the closed door retaining state.

Particularly, first, the key plate 90 is inserted into the first operation hole 15 and is fitted to the tool fitting hole 43B of the manual rotation member 40 positioned at the inner side relative to the first operation hole 15. By rotating the key plate 90 in the clockwise direction viewed from the vehicle interior side in this state, the manual rotation member 40 is rotated in the same direction to the rotating direction of the key plate 90 to rotate the ratchet driving plate 32 in the clockwise direction in FIG. 9. Accordingly, the release lever 34 of the ratchet driving plate 32 moves in a direction being away from the lift lever 35 (i.e., in the downward direction).

In response to the movement of the release lever 34 being away from the lift lever 35, the ratchet 24 rotates towards the latched position, or the latch engagement position by means of the biasing force of the torsion spring 25 to enter the moving range of the latch 23. In a case where the vehicle door 10 is closed in this state, as shown in FIG. 4, the ratchet 24 comes in contact with the front side of the front side engagement pawl 23A of the latch 23. Accordingly, the latch 23 is restricted from being rotated towards the unlatched position (i.e., in the clockwise direction in FIG. 4) and the vehicle door 10 is maintained at the closed state.

As explained above, according to the electric door latch apparatus 20 of the embodiment, the manual rotation member 40 cannot be rotated unless the key plate 90 is inserted via the first operation hole 15 to be fitted to the tool fitting hole 43B. Thus, when the electric door latch apparatus 20 is normally operated, inappropriate changes to the door openable state can be securely prevented by removing the key plate 90 from the tool fitting hole 43B. Further, because the key plate 90 for rotating the manual rotation member 40 is provided on the door trim 19 which is located at a position where a passenger's hand can relatively readily reach and which is readily visible, the visibility of the manual rotation member 40 can be enhanced compared to the known electric door latch apparatuses.

Further, because the manual rotation member 40 is arranged overlapping the sector gear plate 33 formed on the ratchet driving plate 32 in the plate thickness direction, a dimension of the electric door latch apparatus 20 in a direction being orthogonal to the rotational shaft of the ratchet driving plate 32 is downsized compared to a case where the manual rotation member 40 is arranged on a lateral side of the ratchet driving plate 32.

Further, in a case where the manual rotation member 40 is connected to one of the plural motor torque transmitting members, the motor 36 may become an operational resistance when rotating the manual rotation member 40. In response to this drawback, according to the embodiment of the present invention, the rotational axis 40J of the manual rotation member 40 is offset from the driving plate rotational shaft 32J and is positioned closer to the projection portion 33A in a radial direction of the sector gear plate 33 than the driving plate rotational shaft 32J to the projection portion 33A in the radial direction of the sector gear plate 33. In other words, a distance between the rotational axis 40J and the projection portion 33A is shorter than a distance between the projection portion 33A and the driving plate rotational shaft 32J in a radial direction of the sector gear plate 33. Accordingly, with the construction of the embodiment, the operational resistance is reduced compare to a construction in which the rotational axis 40J of the manual rotation member 40 is arranged coaxially to the driving plate rotational shaft 32J.

Further, according to the embodiment, because the manual rotation member 40 is rotated by means of the key plate 90 corresponding to a key plate for starting the engine, it is not necessary for an operator to carry another tool for rotating the manual rotation member 40 with him/her. In addition, this prevents the operator from leaving the tool for rotating the manual rotation member 40 behind somewhere outside the vehicle when using a vehicle.

In those circumstances, because the tool which can contact the manual rotation member 40 arranged within the vehicle door 10 is limited to members which can pass through the rectangular key insertion hole 63A formed on the movable plate 63, for example, the key plate 90 for starting the engine. Thus, the manual rotation member 40 is further securely prevented from being operated with an inappropriate tool.

In a case where the operation lever for manually operating the electric door latch apparatus is positioned away from a vehicle door or a door frame (e.g., under a seat or an instrument panel), a wire is required for connecting the operation lever and the electric door latch apparatus. In those circumstances, this may cause drawbacks such as a decline of workability when assembling the electric door latch apparatus (e.g., handling of the wire) or an increase of the weight due to the wire. However, according to the construction of the embodiment of the present invention, because the key plate 90 and the electric door latch apparatus 20 is directly connected, the aforementioned drawbacks do not happen.

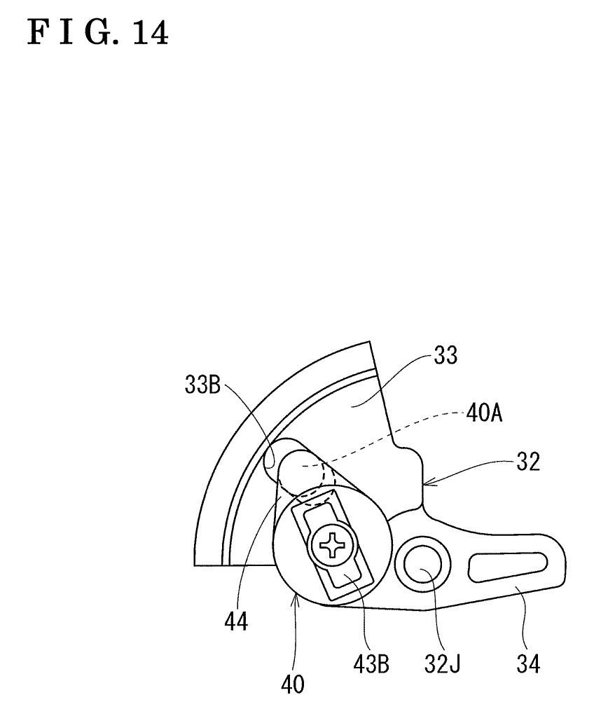

A modified example of the first embodiment is explained hereinbelow. According to the modified example, instead of the projection portion 33A formed on the sector gear plate 33 and the guide slot 41A formed on the manual rotation member 40, a projection portion 40A is formed on the manual rotation member 40 and a guide slot 33B is formed on the sector gear plate 33. More particularly, as shown in FIG. 14, the projection portion 40A projecting towards the sector gear plate 33 is provided on a tip end of a connection plate 44 formed approximately in a triangular shape which extends outwardly in a radial direction of the manual rotation member 40. The projection portion 40A is arranged being offset from the rotational axis 40J of the manual rotation member 40, the guide slot 33B is formed on a middle portion in a circumferential direction of the sector gear plate 33 and has a long hole shape extending in the radial direction of the sector gear plate 33, and the guide slot 33B and the projection portion 40A are engaged via a recess and a projection. According to the construction of the modified example, advantages and effects similar to the first embodiment are attained.

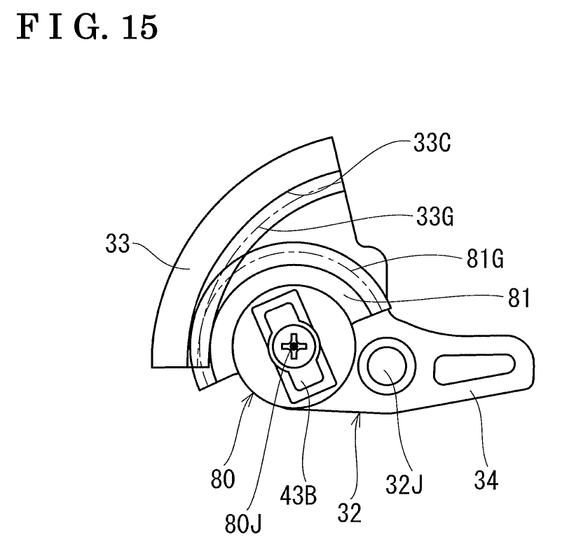

A second embodiment of the present invention will be explained as follows. As shown in FIG. 15, a connection structure between the manual operation portion and the ratchet driving plate according to the second embodiment of the electric door latch apparatus differs from that of the first embodiment. Because other constructions are common to the first embodiment, the same numeral is provided for the same structure and explanations for the common constructions are not repeated.

A manual gear member 80 serving as a manual operation portion includes a construction in which the connection plate 41 of the manual rotation member 40 is replaced by a sector gear plate 81. The sector gear plate 81 extends outwardly in a radial direction of the manual gear member 80, includes approximately half a circle shape, and includes an outer gear 81G at an outer periphery thereof. The manual gear member 80 is arranged overlapping the sector gear plate 33 of the ratchet driving plate 32. A rotational axis 80J of the manual gear member 80 is arranged in parallel to and offset from the driving plate rotational shaft 32J, and is positioned closer to the worm wheel rotational shaft 30J than the driving plate rotational shaft 32J to the worm wheel rotational shaft 30J.

An arc shaped stepped portion 33C is formed on the sector gear plate 33 provided at the ratchet driving plate 32 at a position facing the manual gear member 80 (more particularly, sector gear plate 81). A radially outer portion of the arc shaped stepped portion 33C projects stepwise towards the manual gear member 80. The arc shaped stepped portion 33C includes an arc-like shape having the driving plate rotational shaft 32J as a center. The arc shaped stepped portion 33C is positioned closer to an arc shaped outer periphery of the sector gear plate 33. An arc shaped inner gear 33G is formed on a surface of a step of the arc shaped stepped portion 33C which faces the driving plate rotational shaft 32J. The outer gear 81 G of the sector gear plate 81 provided at the manual gear member 80 is engaged with the inner gear 33G. Accordingly, in response to the rotational operation of the manual gear member 80, the ratchet driving plate 32 rotates in the same direction. With the construction of the second embodiment of the electric door latch apparatus, the advantages and effects similar to the first embodiment can be attained.

Other modified examples will be explained hereinafter. According to the foregoing embodiments, the electric door latch apparatus 20 is structured by the main body unit 21 built in the vehicle door 10 and the operational hole attachment 69 mounted on the door trim 19. However, only the main body unit 21 may construct the electric door latch apparatus 20.

According to the foregoing embodiments, the manual operation portion (the manual rotation member 40, manual gear member 80) is connected to the ratchet driving plate 32. However, the manual operation portion (the manual rotation member 40, manual gear member 80) may be connected to the worm wheel 30 or connected to the worm wheel 30 via the spur gear 31.

According to the foregoing embodiments, the manual operation portion (the manual rotation member 40, the manual gear member 80) is provided separately from the movable plate 63 of the operational hole attachment 69. However, the construction is not limited, and the manual operation portion (the manual rotation member 40, the manual gear member 80) and the movable plate 63 of the operational hole attachment 69 may be integrally formed or may be connected so as to integrally rotate.

According to the foregoing embodiments, the manual operation portion (the manual rotation member 40, the manual gear member 80) is connected to the one of the plural motor torque transmitting members (the ratchet driving plate 32). However, the manual operation (the manual rotation member 40, the manual gear member 80) may be independently provided without connecting to any of the motor torque transmitting members (the worm wheel 30, the spur gear 31, the ratchet driving plate 32) and the lift lever 35 may be directly pushed by the rotation operation of the manual operation portion (the manual rotation member 40, the manual gear member 80). According to this construction, because the operational resistance of the motor 36 is not applied when operating the manual operation portion (the manual rotation member 40, the manual gear member 80), the rotational operation of the manual operation portion can be performed with less force.

According to the foregoing embodiments, the tool fitting hole 43B is configured to fit with the key plate 90 for starting the vehicle engine. However, the tool fitting hole 43B may also be configured to fit with another key plate (e.g., a key for a residential door, a key for motor cycle). Further, the tool fitting hole 43B may be configured to fit with a tool for exclusive use which has a particular cross-sectional configuration which is different from the cross section of the key plate 90 for starting the engine.

Although not mentioned in the foregoing embodiments, a shutter for closing the key insertion hole 63A of the movable plate 63 may be provided in a normal state. Alternatively, a keyhole cap may be detachably provided at the key insertion hole 63A in the normal state.

Although the rotational shaft of the manual operation portion (the manual rotation member 40, the manual gear member 80) is offset from the rotational shaft of the ratchet driving plate 32 according to the foregoing embodiments, the rotational shaft of the manual operation portion (the manual rotation member 40, the manual gear member 80) may be arranged coaxially to the rotational shaft of the ratchet driving plate 32.

The ratchet 24 and the lift lever 35 may be either integrally formed as a single unit or formed as separate parts. Further, according to the foregoing embodiments, the ratchet driving plate 32 is configured to push the lift lever 35. However, alternatively, the ratchet driving plate 32 may be configured to directly push the ratchet 24.

The electric door latch apparatus 20 may be provided at a hinge type door, or a hinged door. Alternatively, the electric door latch apparatus 20 may be provided at a slide type door, or a sliding door.

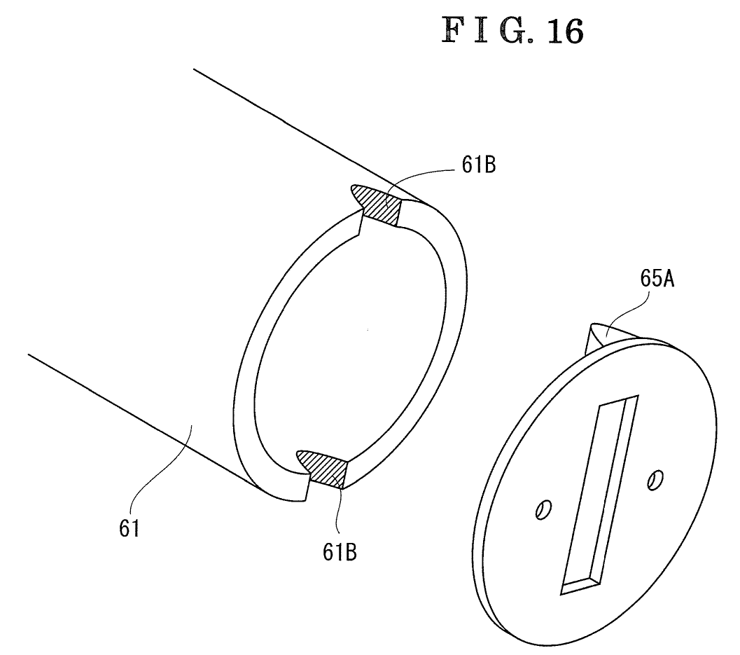

In order to prevent the movable plate 63 from unintentionally rotating relative to the secure ring 60 because of vibrations, or the like, the following construction may be provided. For example, as shown in FIG. 16, notches (recesses) 16B may be formed on a rear end portion of the ring main body 61 and a projection portion 65A which is flexible and is configured to engage with the notches 16B via a recess and a projection are formed on the flange plate 65 of the movable plate 63. According to this construction, in the event that the movable plate 63 rotates relative to the secure ring 60, the projection portion 65A may come out of the notch 16B. Accordingly, unless performing a rotational operation with the tool, the movable plate 63 does not rotate, and thus the a displacement between the key insertion hole 63 and the tool fitting hole 43B due to the vibrations, or the like, is prevented. Further, with this construction, when performing the rotational operation with the inserted tool, the operator can sense a clicking operational feeling.

According to the embodiment, in order to switch the door state to the door openable state in a condition where the electric door latch apparatus 20 is electrically inoperable, the key plate 90 (the predetermined tool) is inserted into the first operation hole 15 (the operation hole) formed on the door trim 19 (the vehicle compartment side wall portion) and is rotated in a state where the key plate 90 (the predetermined tool) is fitted to the tool fitting hole 43B of the manual rotation member 40 or the manual gear member 80 (the manual operation portion). In response to the rotation of the key plate 90 (the predetermined tool), the manual rotation member 40 or the manual gear member 80 (the manual operation portion) integrally rotates with the key plate 90 (the predetermined tool) to switch the door state from the closed door retaining state to the door openable state.

As explained above, according to the construction of the embodiment (of the present invention), it is impossible to operate the manual rotation member 40 or the manual gear member 80 (the manual operation portion) to rotate unless the key plate 90 (the predetermined tool) is inserted through the first operation hole 15 (the operation hole) and fitted to the tool fitting hole 43B. Thus, by removing the key plate 90 (the predetermined tool) from the tool fitting hole 43B in the normal state where the electric door latch apparatus 20 is electrically operable, switching operation to the door openable state by an inappropriate operation, for example, by a child's mischief can be securely prevented. Further, because the key plate 90 (the predetermined tool) for operating the manual rotation member 40 or the manual gear member 80 (the manual operation portion) is mounted on the door trim 19 (the vehicle compartment side wall portion) which is relatively readily reachable and readily visible, the operability of the manual rotation member 40 or the manual gear member 80 (the manual operation portion) is enhanced compared to the known structure in which the operation lever is positioned under the seat.

According to the embodiment of the present invention, the electric door latch apparatus 20 includes the latch 23 rotating for engaging with the striker 13 provided on the vehicle body, the ratchet 24 rotating between the latched position in which the latch 23 is prohibited from rotating in a direction which disengages the striker 13 therefrom and the unlatched position in which the latch 23 is allowed to rotate in a direction which disengages the striker 13 therefrom, the ratchet 24 being biased towards the latched position, the motor 36 performing the electric actuation, and the plural motor torque transmitting members 30, 31, 32 for transmitting a torque of the motor 36 to the ratchet 24. The closed door retaining state is established by positioning the ratchet 24 at the latched position when the vehicle door 10 is at the closed position and the door openable state is established by rotating the ratchet 24 to the unlatched position.

According to the embodiment of the present invention, the electric door latch apparatus 20 further includes the ratchet driving plate 32 rotatably provided as one of the motor torque transmitting members, the ratchet driving plate 32 pushes the lift lever 35 provided at the ratchet 24 in one direction to rotate thereof for rotating the ratchet 24 from the latched position to the unlatched position. The manual rotation member 40 or the manual gear member 80 is connected to or integrally formed with one of the plurality of motor torque transmitting members 30, 31, and 32.

According to the embodiment, because the manual rotation member 40 or the manual gear member (the manual operation portion) 80 is connected to or integrally formed with the ratchet driving plate 32 or the worm wheel 30 or the worm wheel 30 via the spur gear 31 corresponding to one of the plural motor torque transmitting members, the ratchet driving plate 32 can be rotated not only in a direction to push the lift lever (rotational projection portion) 35 but also in a reverse direction (i.e., in a direction being away from the lift lever 35) by the rotational operation of the manual rotation member 40 or the manual gear member (the manual operation portion) 80.

For example, in a case where the manual operation portion is provided separately from the plural motor torque transmitting members and the manual operation portion and the ratchet driving plate are configured to individually push the lift lever (rotational projection portion) of the ratchet, the following drawbacks are caused. That is, in the event that the ratchet assumes not be able to return to the latched position in a condition where the ratchet driving plate pushes the lift lever of the ratchet from one direction (i.e., the ratchet is in the unlatched position, the door openable state), the ratchet cannot be returned to the latched position by operating the manual rotation member or the manual gear member (the manual operation portion) and the door state may not be able to be switched to the closed door retaining state.

On the other hand, according to the construction of the embodiment, even when the ratchet 24 is not returnable to the latched position in a state where the ratchet 24 is in the unlatched position, the ratchet driving plate 32 can be rotated in a direction to separate the ratchet driving plate 32 from the lift lever (rotational projection portion) 35 (i.e., in a reverse direction from the pushing direction) by the rotational operation of the manual rotation member 40 or the manual gear member (the manual operation portion) 80. Accordingly, the ratchet can be securely returned to the latched position. Namely, the door state is securely switched to the closed door retaining state.

According to the embodiment of the electric door latch apparatus 20, the ratchet driving plate 32 includes the sector gear plate 33 engaged with another of the motor torque transmitting members 30, 31, the manual operation portion is arranged overlapping the sector gear plate 33 in a thickness direction thereof and includes the manual rotation member 40 which is rotatable about the rotational axis 40J being in parallel to and being offset from the rotational shaft (32J) of the sector gear (33).

According to the embodiment of the present invention, the electric door latch apparatus further includes the connection mechanism including the projection portion 33A, 40A and the guide slot 41A, 33B, which engages with each other via a projection and a recess. The connection mechanism is formed on opposing surfaces of the manual rotation member 40 and the ratchet driving plate 32. The guide slot 41A, 33B is formed on the opposing surface of one of the manual rotation member 40 and the ratchet driving plate 32 and arranged in a radial direction thereof. The projection portion 33A, 40A is formed on the opposing surface of the other of the manual rotation member 40 and the ratchet driving plate 32 and positioned being away from a rotational center thereof. The manual rotation member 40 and the sector gear plate 33 are rotated in cooperation with each other via the connection mechanism.

According to the embodiments, by rotating the manual rotation member 40 serving as the manual operation portion, the sector gear plate (the sector gear) 33 connected to the manual rotation member 40 via the connection mechanism rotates in response to the rotational operation of the manual rotation member 40 so that the ratchet driving plate 32 having the sector gear plate 33 is rotated. In consequence, the ratchet driving plate 32 pushes the lift lever (rotational projection portion) 35 of the ratchet 24 from one direction to rotate the ratchet 24 from the latched position to the unlatched position. In those circumstances, the rotational axis 40J of the manual rotation member 40 is arranged in parallel with and offset from the driving plate rotational shaft (the rotational shaft of the sector gear) 32J. Because the manual rotation member 40 and the sector gear plate 33 which respectively rotate about the rotational axes arranged being in parallel each other and being offset from each other are rotated in cooperation with each other, the guide slot 33B, or the guide slot 41A of the connection mechanism is configured to extend in a radial direction of the member having the guide slot 33B, or the guide slot 41A. Accordingly, when rotating the manual rotation member 40, the projection portion 33A or the projection portion 40A becomes movable in the guide slot 33B, or the guide slot 41A, thus allowing the manual rotation member 40 to rotate in association with the sector gear plate 33 (ratchet driving plate 32).

According to the embodiments, a dimension of the electric door latch apparatus 20 in a direction being orthogonal to the rotational shaft 32J of the ratchet driving plate 32 is downsized compared to a case where the manual rotation member 40 is arranged on a lateral side of the ratchet driving plate 32.

According to the embodiment of the electric door latch apparatus 20, the ratchet driving plate 32 includes a sector gear 33 engaged with another of the motor torque transmitting members 30, 31, and an arc shaped stepped portion 33C formed on the sector gear 33 at a position closer to an arc shaped outer periphery portion, and an arc shaped inner gear 33G formed on the arc shaped stepped portion 33C.

According to the embodiment of the electric door latch apparatus 20, the manual operation portion is arranged overlapping the sector gear 33 in a thickness direction thereof, is rotatable about the rotational axis 80J being in parallel to and being offset from the rotational shaft 32J of the sector gear 33, and includes the manual gear member 80 having the outer gear 81G configured to engage with the arc shaped inner gear 33G.

According to the embodiments, when rotating the manual gear member 80 serving as the manual operation portion, the sector gear plate (the sector gear) 33 having the arc shaped inner gear 33G engaged with the outer gear 81G of the manual gear member 80 is rotated, and the ratchet driving plate 32 having the sector gear plate 33 is rotated. In consequence, the ratchet driving plate 32 pushes the lift lever (rotational projection portion) 35 of the ratchet 24 to rotate the ratchet 24 from the latched position to the unlatched position.

In those circumstances, because the manual gear member 80 is arranged overlapping the sector gear plate 33 formed on the ratchet driving plate 32 in the plate thickness direction, a dimension of the electric door latch apparatus 20 in a direction being orthogonal to the rotational shaft 32J of the ratchet driving plate 32 is downsized compared to a case where the manual gear member 80 is arranged on a lateral side of the ratchet driving plate 32.

According to the embodiment of the electric door latch apparatus, the manual operation portion 40, 80 is configured to be rotated by inserting therein the key plate (vehicle key) 90 as the predetermined tool.

According to the embodiments, because the manual rotation member 40 or the manual gear member 80 can be rotated by means of the vehicle key, operators can be free from the burden that he/she has to carry another tool for rotating the manual rotation member 40 or the manual gear member 80 separately from the vehicle key.

According to the embodiment of the present invention, the electric door latch apparatus 20 further includes the 60 secure ring being secured to a rim portion of the first operation hole (operation hole) 15 of the vehicle door 10, and the movable plate 63 rotatably assembled to an inside of the secure ring 60. The movable plate includes a rectangular key insertion hole 63A to which the key plate (vehicle key) 90 is insertable.

According to the embodiments, the tool which can contact the manual rotation member 40 or the manual gear member (manual operation portion) 80 is limited to the one having a configuration which can be inserted through the key insertion hole 63A formed in a rectangular shape such as a vehicle key, unwanted operation of the manual rotation member 40 or the manual gear member 80 by an inappropriate tool can be more securely prevented.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. An electric door latch apparatus, comprising:
a manual operation portion adapted to be mounted on a vehicle door and configured to be switched between a closed door retaining state in which the vehicle door is retained at a closed position and a door openable state in which the vehicle door is openable by an electric actuation, the manual operation portion being switched from the closed door retaining state to the door openable state by a manual operation in an electrically inoperable condition; and
the manual operation portion positioned within the vehicle door and including a tool fitting hole on a surface thereof facing a vehicle compartment side wall portion of the vehicle door; wherein
the manual operation portion is configured to be rotated by fitting a predetermined tool into the tool fitting hole via an operation hole formed penetrating through the vehicle compartment side wall portion of the vehicle door.

2. The electric door latch apparatus according to claim 1, further comprising:
a latch rotating for engaging with a striker provided on a vehicle body;
a ratchet rotating between a latched position in which the latch is prohibited from rotating in a direction which disengages the striker therefrom and an unlatched position in which the latch is allowed to rotate in a direction which disengages the striker therefrom, the ratchet being biased towards the latched position;
a motor performing the electric actuation; and
a plurality of motor torque transmitting members for transmitting a torque of the motor to the ratchet; wherein
the closed door retaining state is established by positioning the ratchet at the latched position when the vehicle door is at the closed position and the door openable state is established by rotating the ratchet to the unlatched position.

3. The electric door latch apparatus according to claim 2, further comprising:
a ratchet driving plate rotatably provided as one of the motor torque transmitting members, the ratchet driving plate pushes a rotational projection portion provided at the ratchet in one direction to rotate thereof for rotating the ratchet from the latched position to the unlatched position; wherein
the manual operation portion is connected to or integrally formed with one of the plurality of motor torque transmitting members.

4. The electric door latch apparatus according to claim 2, wherein the ratchet driving plate includes a sector gear engaged with another of the motor torque transmitting members, the manual operation portion is arranged overlapping the sector gear in a thickness direction thereof and includes a manual rotation member which is rotatable about a rotational axis being in parallel to and being offset from a rotational shaft of the sector gear.

5. The electric door latch apparatus according to claim 4, further comprising:
a connection mechanism including a projection portion and a guide slot which engages with each other via a projection and a recess, the connection mechanism being formed on opposing surfaces of the manual rotation member and the ratchet driving plate;
the guide slot being formed on the opposing surface of one of the manual rotation member and the ratchet driving plate and arranged in a radial direction thereof;
the projection portion being formed on the opposing surface of the other of the manual rotation member and the ratchet driving plate and positioned being away from a rotational center thereof; wherein
the manual rotation member and the sector gear are rotated in cooperation with each other via the connection mechanism.

6. The electric door latch apparatus according to claim 5, wherein the projection portion formed in a cylindrical shape is positioned at a middle portion in a circumferential direction of the sector gear and projects towards the manual rotation member; and wherein
the guide slot extends in a radial direction and opens outwards in the radial direction.

7. The electric door latch apparatus according to claim 3, wherein the ratchet driving plate includes a sector gear engaged with another of the motor torque transmitting members, and an arc shaped stepped portion formed on the sector gear at a position closer to an arc shaped outer periphery portion, and an arc shaped inner gear formed on the arc shaped stepped portion.

8. The electric door latch apparatus according to claim 7, wherein the manual operation portion is arranged overlapping the sector gear in a thickness direction thereof, is rotatable about a rotational axis being in parallel to and being offset from a rotational shaft of the sector gear, and includes a manual gear member having an outer gear configured to engage with the arc shaped inner gear.

9. The electric door latch apparatus according to claim 1, wherein the manual operation portion is configured to be rotated by inserting therein a vehicle key as the predetermined tool.

10. The electric door latch apparatus according to claim 9, further comprising:
a secure ring being secured to a rim portion of the operation hole of the vehicle door; and
a movable plate rotatably assembled to an inside of the secure ring, the movable plate including a rectangular key insertion hole to which the vehicle key is insertable.

11. The electric door latch apparatus according to claim 2, further comprising:
a ratchet driving plate rotatably provided as one of the motor torque transmitting members, the ratchet driving plate pushing a rotational projection portion provided at the ratchet in one direction to rotate thereof for rotating the ratchet from the latched position to the unlatched position; wherein
the manual operation portion is independently provided without connecting to the motor torque transmitting member and is configured to directly push the rotational projection portion by the rotational operation of the manual operation portion.

12. The electric door latch apparatus according to claim 3, wherein the ratchet driving plate includes a sector gear engaged with another of the motor torque transmitting members, the manual operation portion is arranged overlapping the sector gear in a thickness direction thereof and includes a manual rotation member which is rotatable about a rotational axis being in parallel to and being offset from a rotational shaft of the sector gear.

13. The electric door latch apparatus according to claim 2, wherein the manual operation portion is configured to be rotated by inserting therein a vehicle key as the predetermined tool.

14. The electric door latch apparatus according to claim 3, wherein the manual operation portion is configured to be rotated by inserting therein a vehicle key as the predetermined tool.

15. The electric door latch apparatus according to claim 4, wherein the manual operation portion is configured to be rotated by inserting therein a vehicle key as the predetermined tool.

16. The electric door latch apparatus according to claim 7, wherein the manual operation portion is configured to be rotated by inserting therein a vehicle key as the predetermined tool.

17. The electric door latch apparatus according to claim 11, wherein the ratchet driving plate includes a sector gear engaged with another of the motor torque transmitting members, the manual operation portion is arranged overlapping the sector gear in a thickness direction thereof and includes a manual rotation member which is rotatable about a rotational axis being in parallel to and being offset from a rotational shaft of the sector gear.

18. The electric door latch apparatus according to claim 11, wherein the ratchet driving plate includes a sector gear engaged with another of the motor torque transmitting members, and an arc shaped stepped portion formed on the sector gear at a position closer to an arc shaped outer periphery portion, and an arc shaped inner gear formed on the arc shaped stepped portion.
